(19) United States
(12) Patent Application Publication
(10) Pub. No.: US 2022/0181095 A1
(43) Pub. Date: Jun. 9, 2022

(54) Universal Bus Plug

(71) Applicants: Garrett Sergio Garcia, Carlsbad, CA (US); Robert Scott Vaughn, Jackson, WY (US)

(72) Inventors: Garrett Sergio Garcia, Carlsbad, CA (US); Robert Scott Vaughn, Jackson, WY (US)

(21) Appl. No.: 17/113,852

(22) Filed: Dec. 7, 2020

(51) Int. Cl. H01H 9/02

(52) U.S. Cl. CPC H01H 9/0207; H01H 9/0072

(57) ABSTRACT

Systems and methods provide an electrical bus plug on a busway, where the electrical bus plug is universal and configured to fit a plurality of busways. An adapter may fit on the electrical bus plug to allow the bus to properly electrically connect with the specific type of busway. Optional mounting brackets can also be removably attached to the universal electrical bus plug to permit attachment to a specific type of busway. Therefore, a single/universal electrical bus plug can be used to electrically connect to a plurality of busway types through the use of an adapter and mounting hardware that attached to the universal bus plug.

### BACKGROUND OF THE INVENTION

### 1. Field of the Invention

Embodiments of the invention relate generally to electrical busway power distribution systems and accessories more particularly, embodiments of the invention relate to a universal bus plug that permits a tap off of a plurality of diverse brands of busway systems with the use of a single bus plug and an interface adapter.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In electrical power distribution, a bus duct (also called busway) is a sheet metal enclosed duct containing either copper or aluminum busbars for the purpose of conducting a substantial current of electricity. It is an alternative means of conducting electricity to power cables or cable bus. Originally, a busway consisted of bare copper conductors supported on inorganic insulators, such as porcelain, mounted within a non-ventilated steel housing.

Busways were produced due to request of the automotive industry in Detroit in the late 1920s. Since that time, busways improved and became an integrated part of secondary power distribution network for industrial plants.

A plug-in bus duct system or busway can have disconnect switches (also known as bus plugs, bus duct plugs, swing plugs or tap offs) and other devices mounted on it, for example, to distribute power internally in an industrial building with numerous access points. Many forms of busway allow for plug-in equipment, such as industrial machinery, to be easily moved; this provides flexibility for changes on an assembly line.

Fusible type bus plugs have been in use for over 50 years. These are used in industrial applications for transferring or distributing power. Bus plugs plug into a busway to add a power tap off and the tap off has circuit protection either with fuses or a circuit breaker. There are over 15 original equipment manufacturers (OEM) that have been making Busway systems for many years. They are installed all over the world.

Some of the bus plug models are completely obsolete and one cannot purchase them from the OEM manufacturer any longer. In these cases, the only option is to buy a refurbished model. These can be unsafe and/or unreliable. Additionally, OEM bus plugs (when available) are expensive and often have long lead times.

In view of the foregoing, this creates challenges for industrial facilities and other end users of busway systems. As a result, there is an important need for a universal bus plug that can interface to various the various types and styles of OEM busways.

### SUMMARY OF THE INVENTION

Aspects of the present invention provide a very high-quality reliable bus plug that could be used universally and plug into all of the various types of OEM busways. Through use of various aspects of the present invention, a user can now have a new UL listed product to distribute power from an existing OEM busway, providing a safe and reliable switch and/or circuit protection while preventing the need for an entire busway retrofit, replacement or upgrade. Further, the universal bus plug according to aspects of the present invention is easily manufactured and can be provided at significantly less cost than the comparable OEM equipment, if even available from the OEM.

Embodiments of the present invention provide a universal bus plug comprising an enclosure; a switch or breaker located inside the enclosure; an interface providing electrical connection from outside the enclosure to the switch or breaker; and a plurality of mounting openings configured to receive one of a plurality of mounting hardware sets, the one of the plurality of mounting hardware sets configured to provide mounting of the universal bus plug to a particular type of busway, wherein other ones of the plurality of mounting hardware sets provide mounting of the universal bus plug to other types of busway.

Embodiments of the present invention further provide a universal bus plug comprising an enclosure; a switch or breaker located inside the enclosure; an interface providing electrical connection from outside the enclosure to the switch or breaker; and an interface adapter configured to electrically connect a particular type of busway to the interface.

Embodiments of the present invention also provide a universal bus plug system comprising an enclosure; a switch or breaker located inside the enclosure; an interface providing electrical connection from outside the enclosure to the switch or breaker; a plurality of mounting openings pre-formed in the housing and configured to receive a plurality of mounting hardware sets, a selected one of the plurality of mounting hardware sets corresponding for mounting to a desired busway type for mounting the universal bus plug, other ones of the plurality of mounting hardware sets correspond to mounting to other busway types; and an interface adapter configured to electrically connect the desired busway type to the interface.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a universal bus plug for 30-60 Amp (A) circuits with a front face open according to an exemplary embodiment of the present invention;

FIG. 2 illustrates the universal bus plug of FIG. 1 with the front face closed;

FIG. 3 illustrates a switch usable in the universal bus plug of FIG. 1;

FIG. 4 illustrates a universal bus plug for 100 A circuits with a front face open according to an exemplary embodiment of the present invention;

FIG. 5 illustrates the universal bus plug of FIG. 4 with the front face closed;

FIG. 6 illustrates an exploded front perspective view of the universal bus plug of FIG. 1 with an interface adapter for ITAP type from the POW-R-WAY® family of busways by Cutler Hammer/Eaton OEM brand busways, according to an exemplary embodiment of the present invention;

FIG. 7 illustrates an exploded rear view of the universal bus plug of FIG. 6;

FIG. 8 illustrates an exploded front perspective view of the universal bus plug of FIG. 4 with an interface adapter for ITAP type busways, according to an exemplary embodiment of the present invention;

FIG. 9 illustrates an exploded rear view of the universal bus plug of FIG. 8;

FIG. 10 illustrates an exploded front perspective view of the universal bus plug of FIG. 1 with an interface adapter for RV type from the XL-X™ family of busways by ITE/Siemens OEM brand busways, according to an exemplary embodiment of the present invention;

FIG. 11 illustrates an exploded rear view of the universal bus plug of FIG. 10;

FIG. 12 illustrates an exploded front perspective view of the universal bus plug of FIG. 4 with an interface adapter for UV type from the XL-Universal family of busways by ITE/Siemens OEM brand busways, according to an exemplary embodiment of the present invention;

FIG. 13 illustrates an exploded rear view of the universal bus plug of FIG. 12;

FIG. 14 illustrates an exploded front perspective view of the universal bus plug of FIG. 1 with an interface adapter for UV type busways, according to an exemplary embodiment of the present invention;

FIG. 15 illustrates an exploded rear view of the universal bus plug of FIG. 14;

FIG. 16 illustrates an exploded front perspective view of the universal bus plug of FIG. 4 with an interface adapter for UV type busways, according to an exemplary embodiment of the present invention;

FIG. 17 illustrates an exploded rear view of the universal bus plug of FIG. 16;

FIG. 18 illustrates the universal bus plug of FIGS. 6 and 7 installed on an ITAP type busway;

FIG. 19 illustrates the universal bus plug of FIGS. 8 and 9 installed on an ITAP type busway;

FIG. 20 illustrates the universal bus plug of FIGS. 10 and 11 installed on an RV type busway;

FIG. 21 illustrates the universal bus plug of FIGS. 12 and 13 installed on an RV type busway;

FIG. 22 illustrates the universal bus plug of FIGS. 14 and 15 installed on an UV type busway;

FIG. 23 illustrates the universal bus plug of FIGS. 16 and 17 installed on an UV type busway;

FIG. 24 illustrates an EGH type breaker usable in the universal bus plug according to embodiments of the present invention;

FIG. 25 illustrates the EGH type breaker of FIG. 24 installed in a universal bus plug;

FIG. 26 illustrates an FAL type breaker usable in the universal bus plug according to embodiments of the present invention;

FIG. 27 illustrates the FAL type breaker of FIG. 26 installed in a universal bus plug;

FIG. 28 illustrates an HDL type breaker usable in the universal bus plug according to embodiments of the present invention;

FIG. 29 illustrates the HDL type breaker of FIG. 28 installed in a universal bus plug;

FIG. 30 illustrates a large ED2 type breaker usable in the universal bus plug according to embodiments of the present invention; and

FIG. 31 illustrates the ED2 type breaker of FIG. 30 installed in a universal bus plug.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods for providing an electrical bus plug on a busway, where the electrical bus plug is universal and configured to fit a plurality of busways. An adapter may fit on the electrical bus plug to allow the bus to properly electrically connect with the specific brand or type of busway. Optional mounting brackets can also be removably attached to the universal electrical bus plug to permit attachment to a specific brand or type of busway. Therefore, a single/universal electrical bus plug can be used to electrically connect to a plurality of busway brands or types through the use of an adapter and mounting hardware that attached to the universal bus plug.

For the modularity of the universal bus plug, an interface is designed which allows adapter kits to be built and reconfigured so that the main unit can fit different OEM busways/ducts. These interfaces can be designed and tested to the UL857 standard and are important for the reliability for the final product. Regardless of the type of busway the bus plug is being affixed to, the universal bus plug, according to aspects of the present invention, remains identical with the exception of the stab configuration (adapter attached to the bus plug interface) and hangers/mounting hardware. This provides reassurance that the overall reliability and function will remain constant. Streamlining the design process and adopting the universal bus plug concept provides an extremely competitive product and solves problems associated with long production lead times, in-availability of new products, and the like.

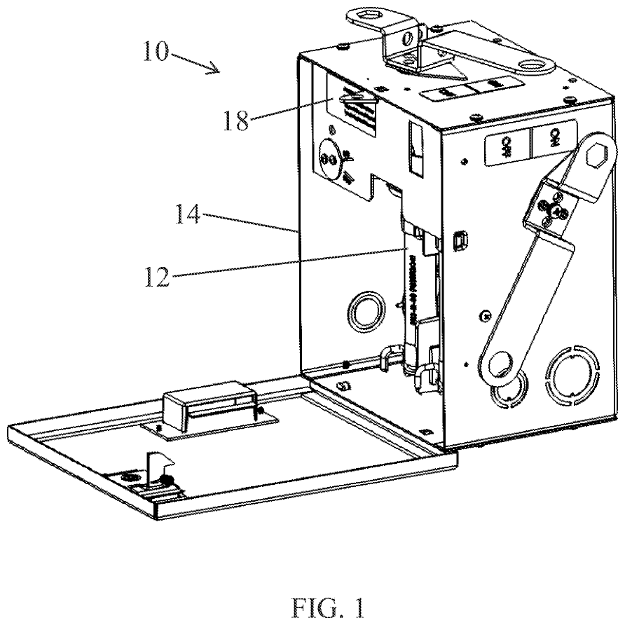

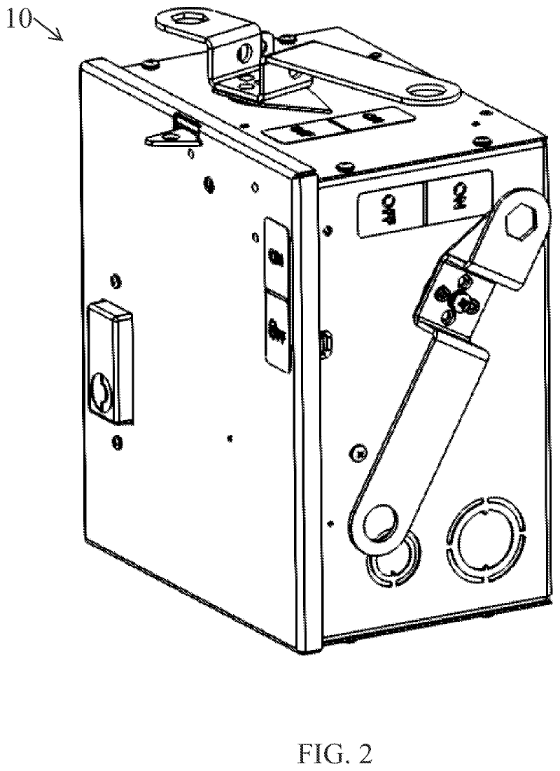

Referring to FIGS. 1 and 2, a universal bus plug 10 can include an electrical fusible switch or circuit breaker 12, also referred to as switch/breaker 12 or simply as breaker 12, inside the housing 14 (also referred to as enclosure 14) of the bus plug 10. The universal bus plug 10 can include an electrical connection opening 16 (also referred to as interface 16), typically on a rear side thereof. The electrical connection opening 16 can provide plug-in electrical connectors for a typical electrical power supply, such as a three-phase, 240V power supply. Of course, the electrical connection opening 16 can be configured to provide power input of various types of electrical power supply, depending on the application.

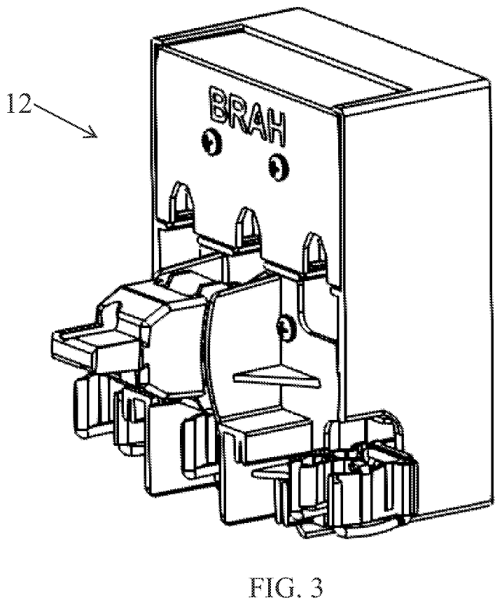

FIG. 3 illustrates one example of a switch/breaker 12 that can be configured in the universal bus plug 10. This switch/breaker 12 may be a three-phase floating contact switch as described in U.S. Pat. No. 10,141,125, the contents of which are herein incorporated by reference.

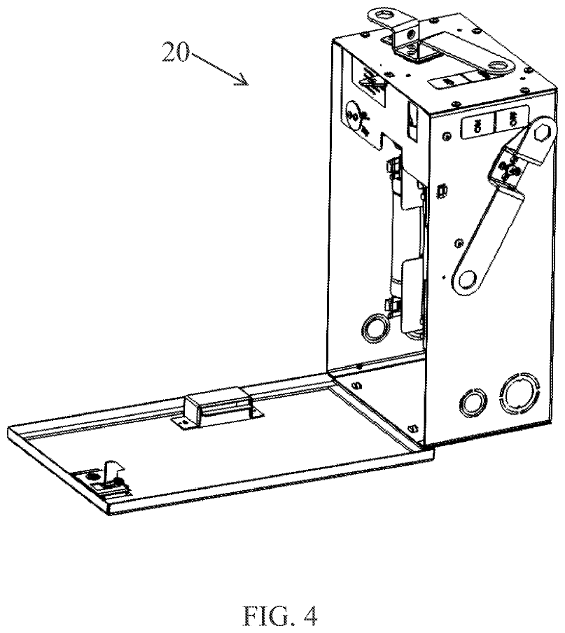

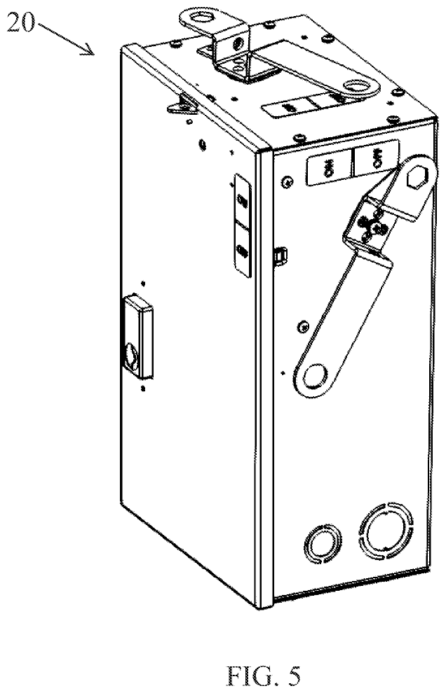

FIGS. 4 and 5 illustrate a universal bus plug 20 similar to that of FIGS. 1 and 2, where the universal bus plug 10 of FIGS. 1 and 2 may be designed for 30-60 Amp circuits, while the universal bus plug 20 of FIGS. 4 and 5 may be designed for 100 Amp circuits. It should be understood that the specific embodiments described herein, related to specific current-rated circuits, may be changed depending on the specific application. For example, while 30 A, 60 A and 100 A circuits are described, aspects of the present invention may be applied to circuits up to 2500 A, depending on the desired application. Further, it should be understood that aspects of the present invention may be usable with systems having various voltages, typically systems having voltages less than 600V.

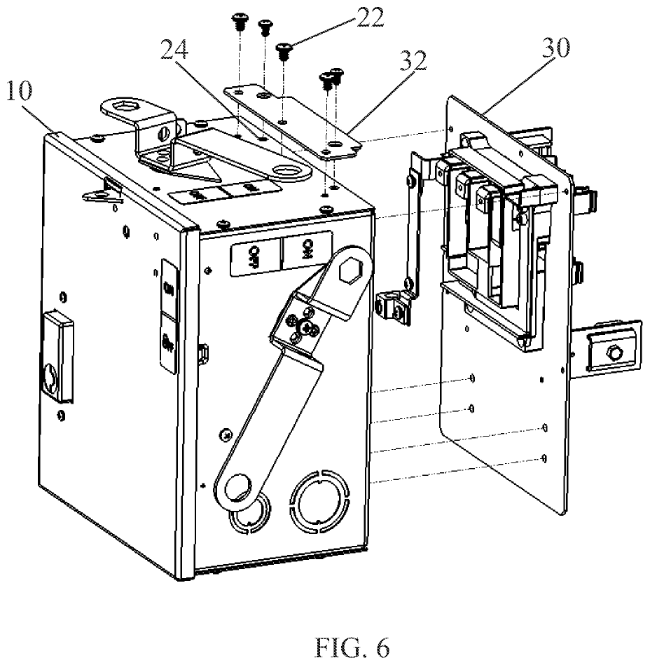

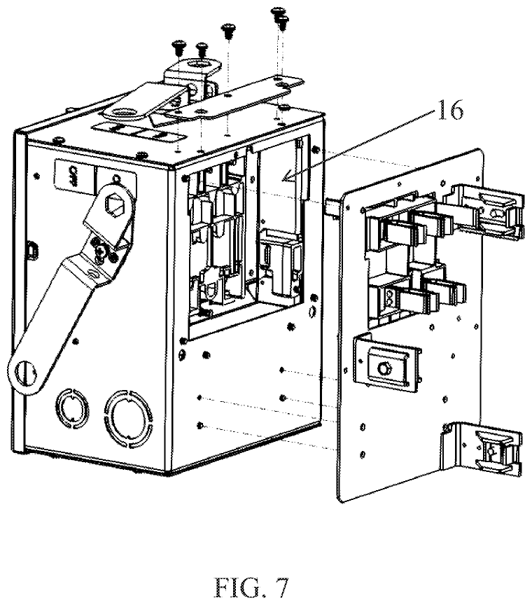

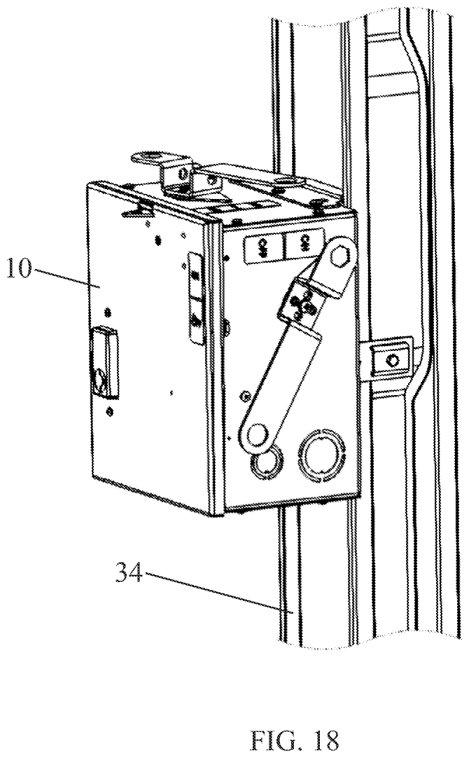

FIGS. 6 and 7 illustrate front and rear views of the universal bus plug 10 with an adapter 30 configured to electrically connect the rear connector opening 16 with an ITAP type busway. Thus, to use the universal bus plug 10 with an ITAP type (30-60 A) busway, the user can simply apply the proper adapter 30 to the rear of the universal bus plug 10. Mounting hardware 32 suited for hanging the universal bus plug 10 on an ITAP type (30-60 A) busway 34 (see FIG. 18) can be attached as shown. For example, screws 22 can pass through holes in the mounting hardware 32 and be threaded into mounting openings 24 pre-formed in the universal bus plug 10. In some embodiments, the mounting openings 24 may be threaded to receive the mating threads of the screws 22.

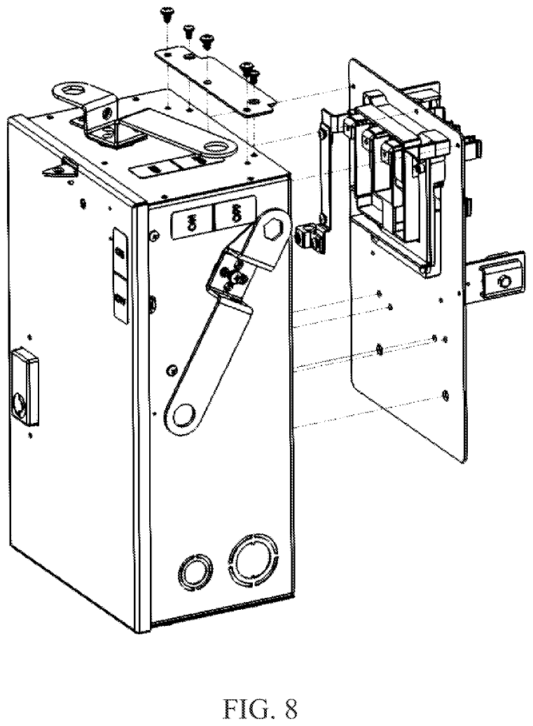

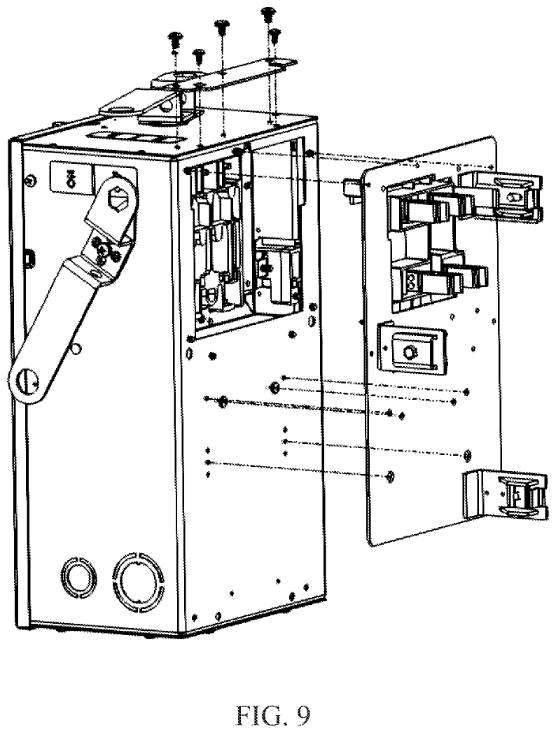

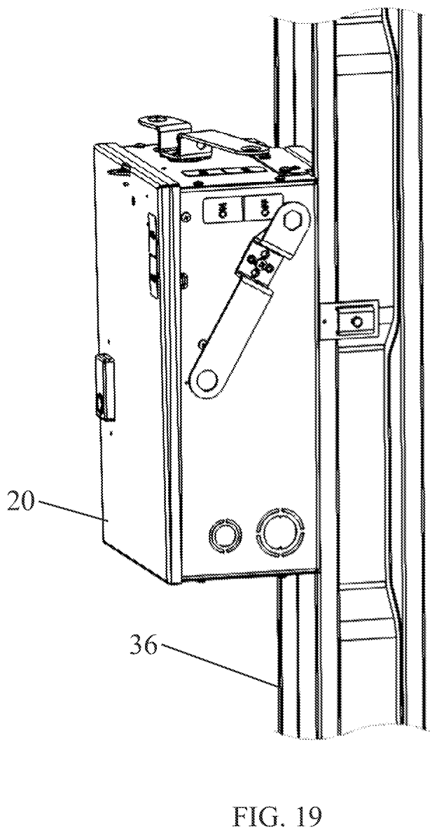

FIGS. 8 and 9 illustrate front and rear views of the universal bus plug 20 of FIGS. 4 and 5, designed for 100 Amp circuits, with an adapter configured to attach the interface 16 of the universal bus plug 20 to an ITAP type busway. Thus, to use the universal bus plug 20 with an ITAP type (100 A) busway, the user can simply apply the proper adapter to the rear of the universal bus plug 10. Mounting hardware 32 suited for hanging the universal bus plug 20 on an ITAP type 100 A busway 36 (see FIG. 19) can be attached as shown.

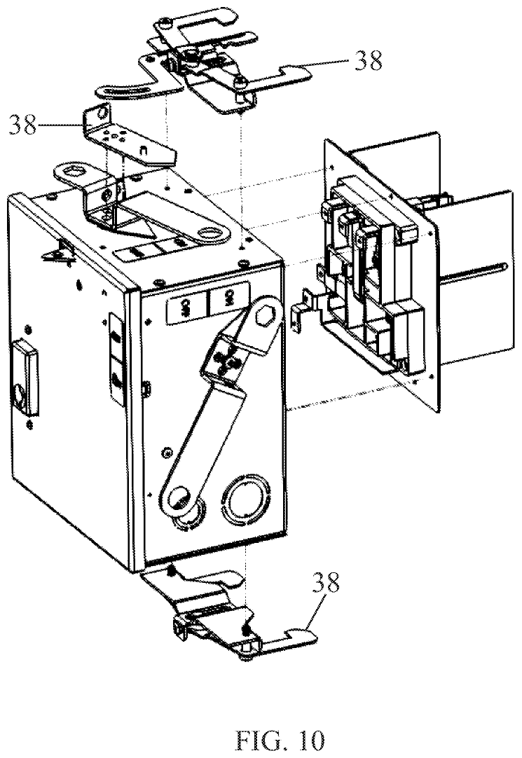

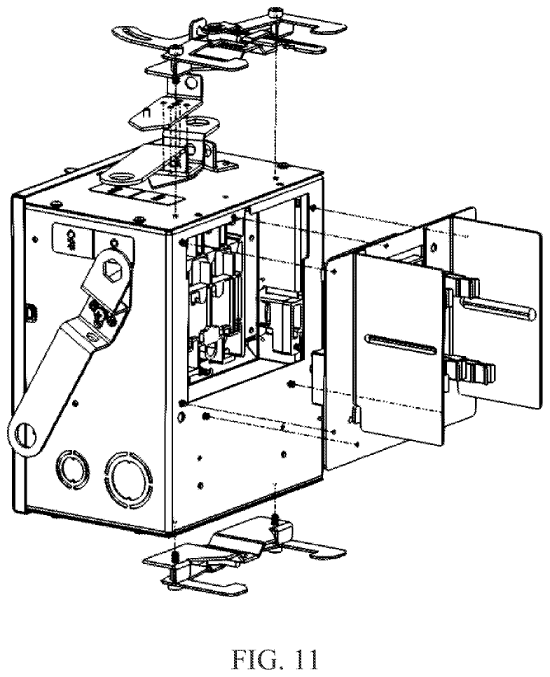

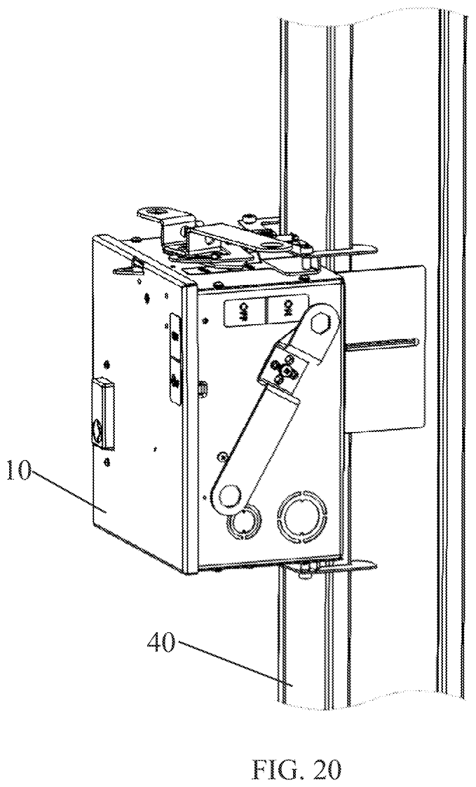

FIGS. 10 and 11 illustrate front and rear views of the universal bus plug 10 with an adapter 30 configured to electrically connect the rear connector opening 16 with an RV type busway. Thus, to use the universal bus plug 10 with an RV type (30-60 A) busway, the user can simply apply the proper adapter 30 to the rear of the universal bus plug 10. Mounting hardware 38 suited for hanging the universal bus plug 10 on an RV type (30-60 A) busway 40 (see FIG. 20) can be attached as shown.

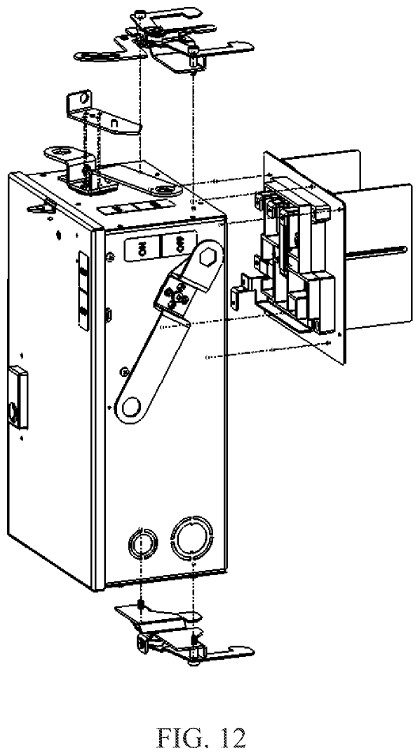

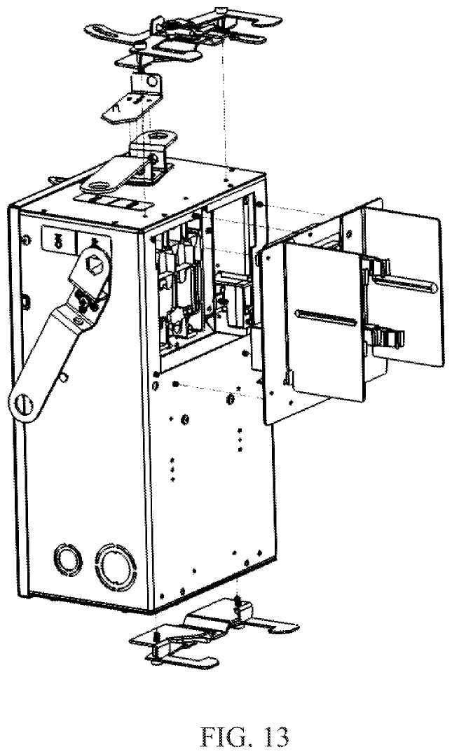

FIGS. 12 and 13 illustrate front and rear views of the universal bus plug 20 of FIGS. 4 and 5, designed for 100 Amp circuits, with an adapter configured to attach the interface 16 of the universal bus plug 20 to an RV type busway. Thus, to use the universal bus plug 20 with an RV type (100 A) busway, the user can simply apply the proper adapter to the rear of the universal bus plug 10. Mounting hardware 38 suited for hanging the universal bus plug 20 on an RV type 100 A busway 42 (see FIG. 21) can be attached as shown.

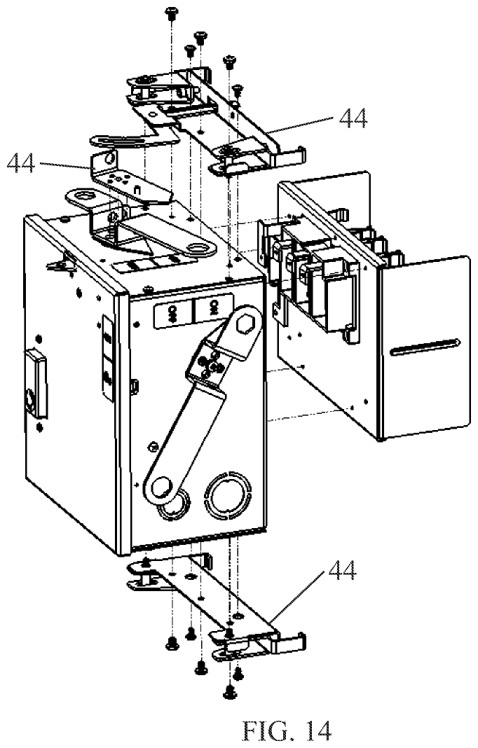

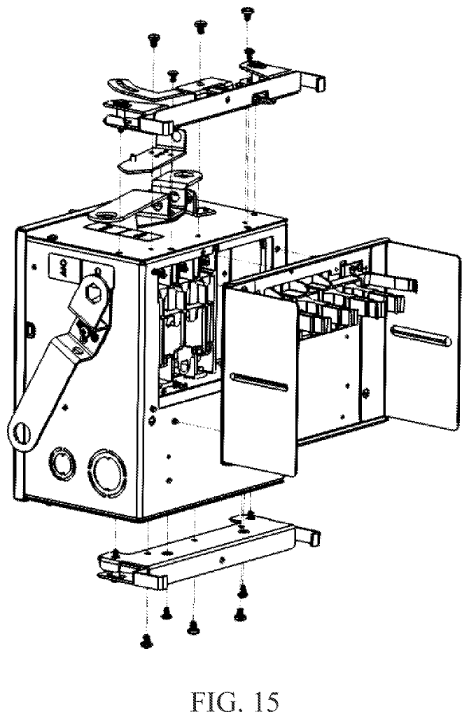

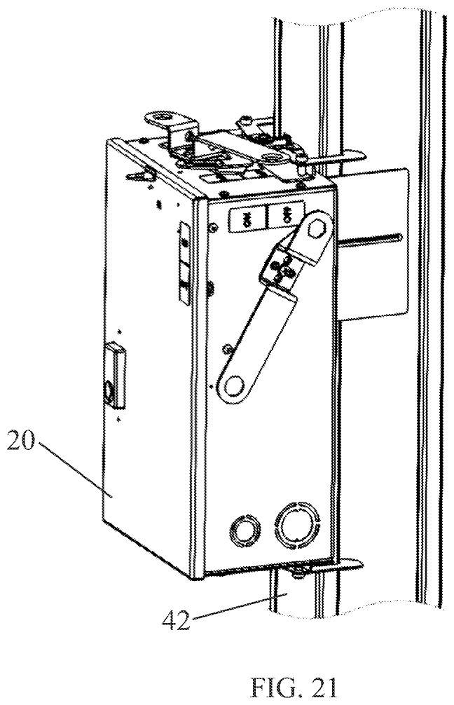

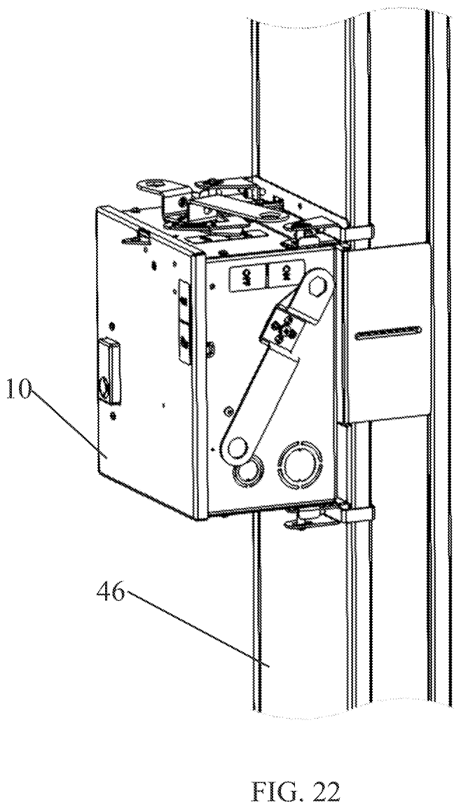

FIGS. 14 and 15 illustrate front and rear views of the universal bus plug 10 with an adapter 30 configured to electrically connect the rear connector opening 16 with an UV type busway. Thus, to use the universal bus plug 10 with an UV type (30-60 A) busway, the user can simply apply the proper adapter 30 to the rear of the universal bus plug 10. Mounting hardware 44 suited for hanging the universal bus plug 10 on an UV type (30-60 A) busway 46 (see FIG. 22) can be attached as shown.

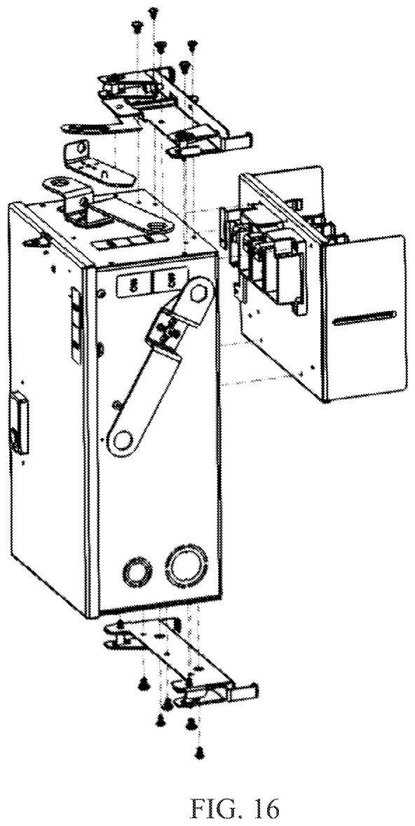

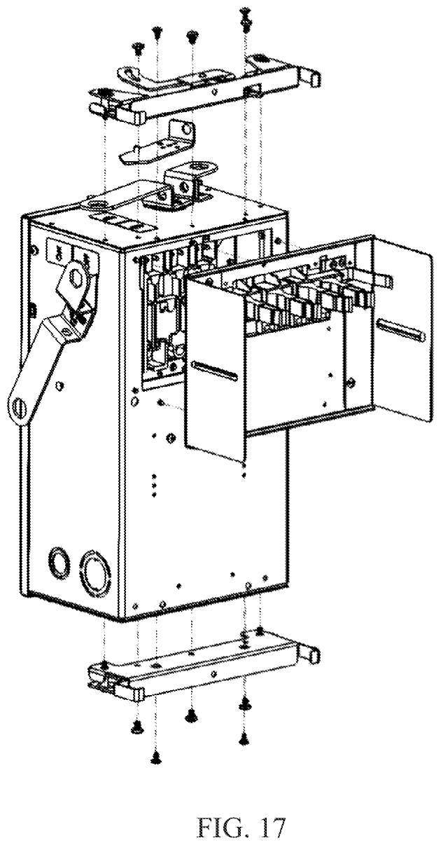

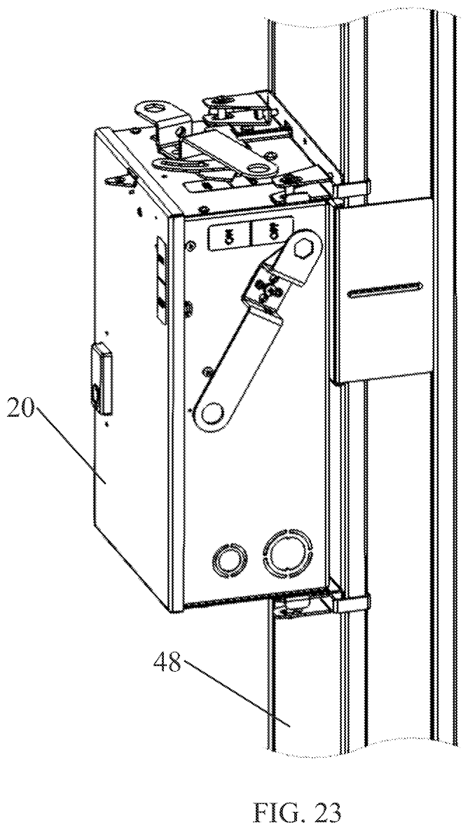

FIGS. 16 and 17 illustrate front and rear views of the universal bus plug 20 of FIGS. 4 and 5, designed for 100 Amp circuits, with an adapter configured to attach the interface 16 of the universal bus plug 20 to an UV type busway. Thus, to use the universal bus plug 20 with an UV type (100 A) busway, the user can simply apply the proper adapter to the rear of the universal bus plug 10. Mounting hardware 44 suited for hanging the universal bus plug 20 on an UV type (100 A) busway 48 (see FIG. 23) can be attached as shown.

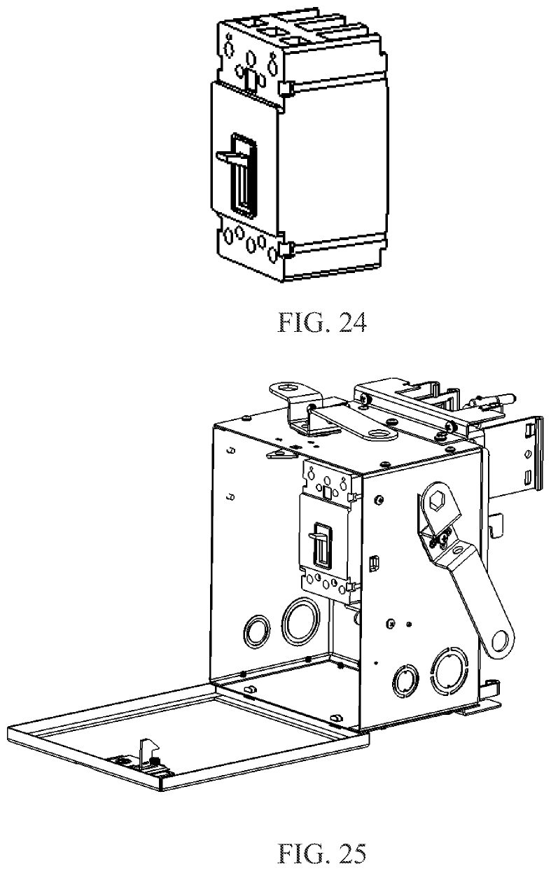

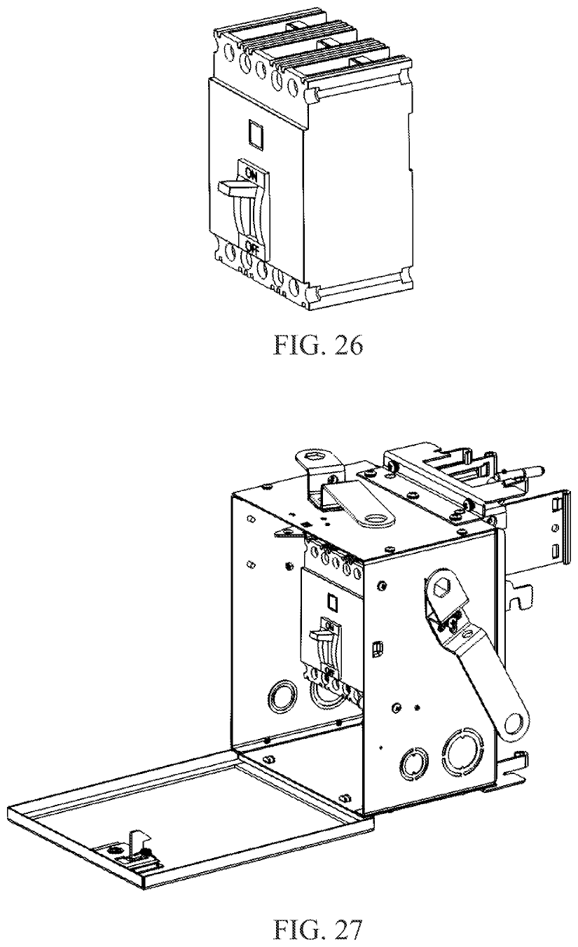

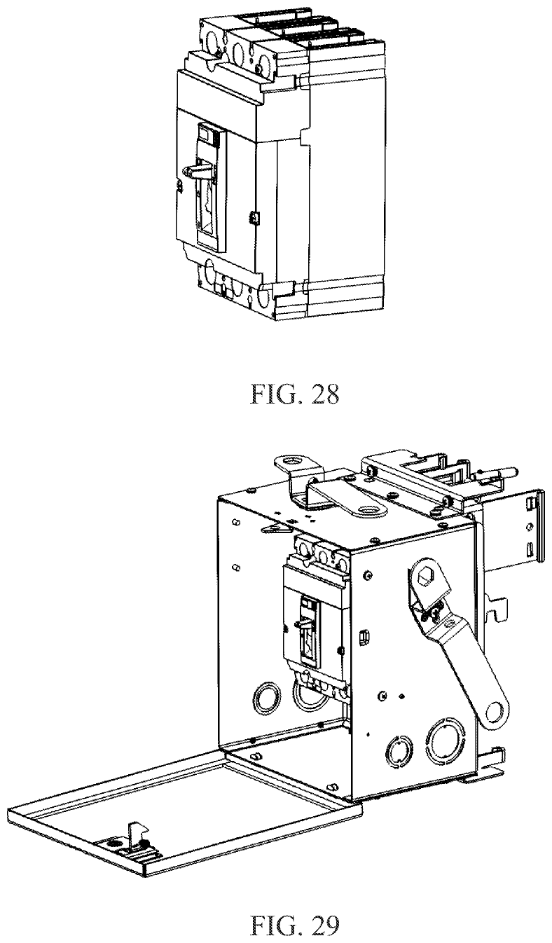

FIGS. 24 through 29 illustrate different small breakers that can be installed in the universal bus plug 10 of FIGS. 1 and 2. Such small breakers can include EHG breakers (FIGS. 24 and 25), FAL breakers (FIGS. 26 and 27) and HDL breakers (FIGS. 28 and 29). Other small breakers can include HEB, HED, NDG, SEL and TED breakers, for example.

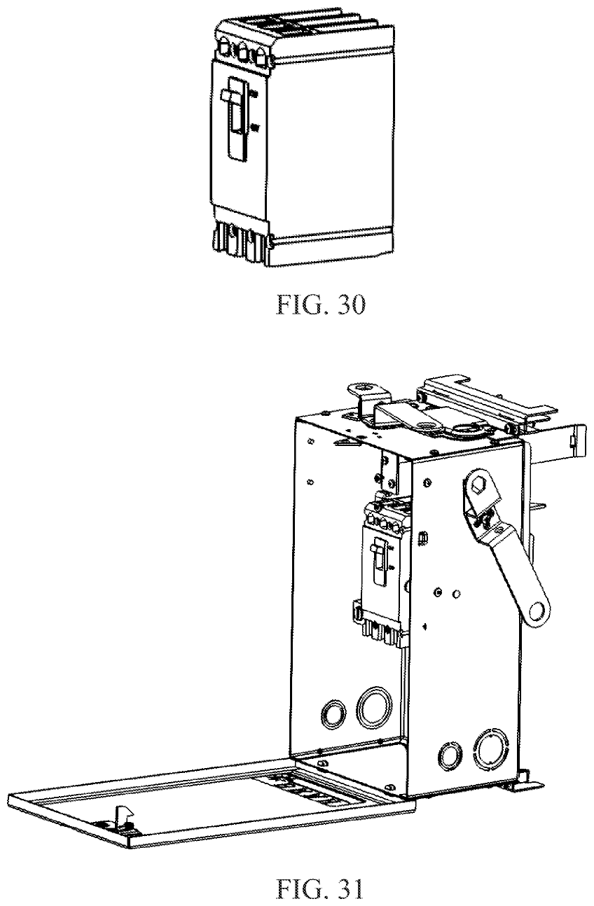

FIGS. 30 and 31 illustrate a large (100 A) breaker, such as a ED2 breaker, that can be installed in the universal bus plug 20 of FIGS. 4 and 5. Other large breakers can include FXD, JD3, JGH, JGL, KAL, NSF, SFL and TFJ breakers, for example. Of course, other breaker types, and other breaker amperages may be used in various embodiments of the present invention.

In some embodiments, the universal bus plugs 10, 20 can include a hard-wired or wireless interface 18 (See FIG. 1) disposed within the housing that can provide a wireless signal to a central computer system, a mobile computer system, a wireless power meter, or the like, for monitoring various aspects of the universal bus plug. The wireless interface device can measure current through the bus plug, state of the switch/breaker, temperature of the switch/breaker, and the like. The wireless interface can include an alert function to either provide an alert at the bus plug or send the alert to a remote computer and/or user. The alert may be provided if the wireless interface, or any sensor attached thereto, detects a condition suitable for generating such an alert.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A universal bus plug comprising:
an enclosure;
a switch or breaker located inside the enclosure;
an interface providing electrical connection from outside the enclosure to the switch or breaker; and
a plurality of mounting openings configured to receive one of a plurality of mounting hardware sets, the one of the plurality of mounting hardware sets configured to provide mounting of the universal bus plug to a particular type of busway, wherein other ones of the plurality of mounting hardware sets provide mounting of the universal bus plug to other types of busway.

2. The universal bus plug of claim 1, further comprising an interface adapter configured to electrically connect the particular type of busway to the interface.

3. The universal bus plug of claim 1, further comprising a wireless interface disposed in the enclosure, the wireless interface configured to send information about the universal bus plug to a remote computing device.

4. The universal bus plug of claim 1, wherein the switch or breaker is interchangeable inside the enclosure.

5. The universal bus plug of claim 1, wherein the interface provides a three-phase electrical connection.

6. The universal bus plug of claim 1, wherein the mounting openings are pre-formed in the enclosure at locations for placement of two or more sets of mounting hardware, where each of the two or more sets of mounting hardware are configured for attachment to different types of busway.

7. The universal bus plug of claim 1, wherein the switch or breaker is a fusible switch or breaker.

8. A universal bus plug comprising:
an enclosure;
a switch or breaker located inside the enclosure;
an interface providing electrical connection from outside the enclosure to the switch or breaker; and
an interface adapter configured to electrically connect a particular type of busway to the interface.

9. The universal bus plug of claim 8, further comprising a plurality of mounting openings configured to receive two or more of a plurality of mounting hardware sets, each of the two or more of the plurality of mounting hardware sets are configured for attachment to different type of busway.

10. The universal bus plug of claim 8, further comprising an interface disposed in the enclosure, the wireless interface configured to send information about the universal bus plug to a remote computing device.

11. The universal bus plug of claim 8, wherein the switch or breaker is interchangeable inside the enclosure.

12. The universal bus plug of claim 8, wherein the interface provides a three-phase electrical connection.

13. The universal bus plug of claim 8, wherein the mounting openings are pre-formed in the enclosure at locations for placement of two or more sets of mounting hardware, where each of the two or more sets of mounting hardware are configured for attachment to different types of busway.

14. A universal bus plug system comprising:
an enclosure;
a switch or breaker located inside the enclosure;
an interface providing electrical connection from outside the enclosure to the switch or breaker;
a plurality of mounting openings pre-formed in the enclosure and configured to receive a plurality of mounting hardware sets, a selected one of the plurality of mounting hardware sets corresponding for mounting to a desired busway type for mounting the universal bus plug, other ones of the plurality of mounting hardware sets correspond to mounting to other busway type; and
an interface adapter configured to electrically connect the desired busway type to the interface.

15. The universal bus plug of claim 14, further comprising a second interface adapter configured to electrically connect the interface to one of the other busway types.

16. The universal bus plug of claim 14, further comprising a wireless interface disposed in the enclosure, the wireless interface configured to send information about the universal bus plug to a remote computing device.

17. The universal bus plug of claim 14, wherein the switch or breaker is interchangeable inside the enclosure.

18. The universal bus plug of claim 14, wherein the interface provides a three-phase electrical connection.
